(19) United States
(12) Patent Application Publication
(10) Pub. No.: US 2010/0327536 A1
(43) Pub. Date: Dec. 30, 2010

(54) BRUSH SEAL AND METHOD FOR MOUNTING A BRUSH SEAL

(75) Inventor: Stefan Beichl, Herrsching (DE)

Correspondence Address: CROWELL & MORING LLP;INTELLECTUAL PROPERTY GROUP, P.O. BOX 14300, WASHINGTON, DC, 20044-4300, US

(73) Assignee: MTU Aero Engines GmbH, Munich (DE)

(21) Appl. No.: 12/865,074

(22) PCT Filed: Jan. 20, 2009
(86) PCT No.: PCT/DE2009/000062

§ 371 Date: Jul. 28, 2010

(30) Foreign Application Priority Data
Jan. 29, 2008 (DE) 10 2008 006 485.8

(51) Int. Cl. F16J 15/16; B23P 17/04

(52) U.S. Cl. 277/355; 29/428

(57) ABSTRACT

A brush seal and a method for mounting a brush seal is disclosed. The brush seal includes a sealing element provided with a plurality of filaments or wires that are joined at a filament or wire end to form a filament or wire bundle. The filament or wire end is arranged in a mounting recess of a housing. A free end of the filament or wire bundle protrudes from the housing and is opposite from the filament or wire end. At least one projection is formed on an inner contour of the mounting recess in such a manner that the filament or wire bundle is clamped by the projection at a predefined distance from the filament or wire end.

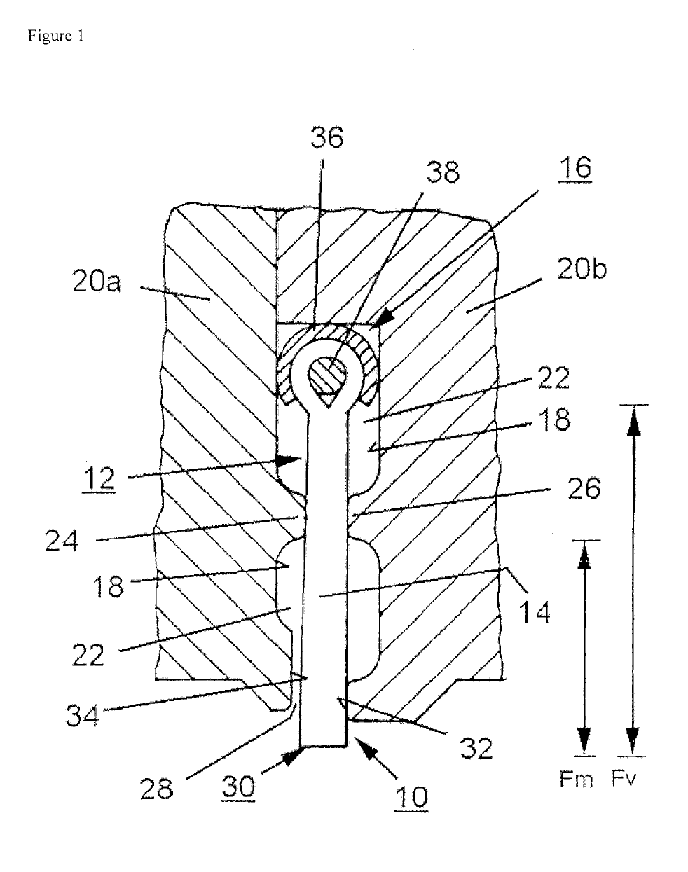

This application claims the priority of International Application No. PCT/DE2009/000062, filed Jan. 20, 2009, and German Patent Document No. 10 2008 006 485.8, filed Jan. 29, 2008, the disclosures of which are expressly incorporated by reference herein.

### BACKGROUND AND SUMMARY OF THE INVENTION

The present invention relates to a brush seal comprising a sealing element provided with a plurality of filaments or wires that are joined at a filament or wire end to form a filament or wire bundle, the filament or wire end being arranged in a mounting recess of a housing, and also comprising a free end of the filament or wire bundle that protrudes from the housing and that is opposite from the filament or wire end. The invention also relates to a method for mounting a brush seal.

A great variety of brush seals of the type cited at the outset are known and are used for example in gas turbines to seal the intermediate space between the housing and a rotor rotating at a relatively high speed against leaks. A corresponding brush seal is described for example in U.S. Patent Application Publication No. 2007/0132189 A1. The disadvantage of known brush seals, however, is that the basic stiffness of the brush seal required for the respective intended use must be adjusted with appropriate measures already prior to mounting the brush seal in the respective machine. Thus, until now brush seals were built with a permanently fixed free filament length. In this case, the free filament length is understood as that section of the filament or wire bundle that is not surrounded by a clamping element or welding area or adhesion area for fixing and bundling the individual filaments and wires. Thus, it was discovered, for example, when using Kevlar brush seals in machine tool rotating unions, that the required leak tightness could only be achieved with very short filament lengths. In the process, it was observed that an unacceptably high heat build-up may occur. In order to limit this build-up of heat, the brush seal in this cited example is paired with the shaft in order to achieve the required basic stiffness of the brush seal. This approach is not economical and hard to control logistically.

As a result, the objective of the present invention is making available a generic brush seal whose basic stiffness is adjustable.

A further objective of the present invention is providing a method for mounting a brush seal, which makes it possible to adjust and adapt the basic stiffness of the brush seal to the individual requirements of the environment being sealed.

A brush seal according to the invention has a sealing element provided with a plurality of filaments and wires, wherein the filaments and wires are joined at a filament or wire end to form a filament or wire bundle, the filament or wire end being arranged in a mounting recess of a housing, and also comprising a free end of the filament or wire bundle that protrudes from the housing and that is opposite from the filament or wire end. In addition, at least one projection is formed on an inner contour of the mounting recess in such a manner that the filament or wire bundle is clamped by the projection at a predefined distance from the filament or wire end. In the case of the brush seal according to the invention, the basic stiffness of the filament or wire bundle or the leak tightness of the seal is not adjusted until after mounting or until the time the brush seal is mounted in the housing. In the process, the filaments or wires are clamped between one or more projections of the inner contour of the mounting recess of the housing. The distance from the filament or wire end may be varied so that the free filament length and thus the basic stiffness of the brush seal may be adapted individually to the requirements of the environment being seal. In addition, the brush seal may be fabricated with normal fabrication tolerances, because any applicable very high basic stiffness of the brush seal is achieved after mounting the brush seal. As a result, the leak tightness as well as the heat build-up may be adjusted, for example, during operation without the brush seal having to be paired with a shaft. The costs of manufacturing and mounting as well as logistical time and effort are thereby reduced considerably. Therefore, the brush seal can be fabricated with long filaments that have a low basic stiffness. When the brush seal is mounted, the filaments or wires are clamped in a predetermined area in the mounting recess by the projection(s) in such a way that the clamped filaments or wires function in a manner analogous to a brush seal having shorter filaments. The projection in this case may be configured as a projection that is at least partially circumferentially on the inner contour. But it is also possible for at least two projections to be formed opposite from each other on the inner contour.

In an advantageous embodiment of the brush seal according to the invention, the filament or wire end is fabricated of a core wire, around which the plurality of filaments or wires is wound, and a clamping element, in particular a clamping tube, wherein the clamping element is used for fixing and bundling the filaments and wires. However, it is also possible for the filament or wire end to have a welding or adhesion area for fixing and bundling the filaments and wires. According to the invention, different types of sealing elements may be used.

In other advantageous embodiments of the brush seal according to the invention, at least one supporting surface, on which the free end is at least partially supported, is formed on the inner contour of the mounting recess in the area of an outlet opening for the free end of the filament or wire bundle. In addition, it is also possible for a second supporting surface for the free end of the filament or wire bundle to be formed on an area of the inner contour opposite from the supporting surface. The supporting surfaces of the housing advantageously assume a supporting or covering function in this case, which, in the case of known brush seals, is normally performed by respectively separate elements. The first supporting surface may also be configured to be spaced apart from the free end of the filament or wire bundle. This makes it possible to advantageously avoid undesired contact between the housing and opposing machine parts.

In other advantageous embodiments of the brush seal according to the invention, the housing featuring the mounting recess is configured to be multi-piece or one-piece.

According to other advantageous embodiments of the brush seal according to the invention, the housing in which the brush seal is mounted may be a structural element of an aircraft or stationary gas turbine, a compressor, a steam turbine or a machine tool. Basically, the brush seal may be used in all machines in which a gap between two structural elements of the machine must be sealed.

A method for mounting a brush seal in a housing according to the invention includes the following steps: a) Making available a brush seal comprising a sealing element provided with a plurality of filaments or wires, which are joined at a filament or wire end to form a filament or wire bundle and a free end of the filament or wire bundle that protrudes from the housing and that is opposite from the filament or wire end; and b) Inserting and fixing the brush seal in a mounting recess of the housing, wherein the filament or wire bundle is clamped at a predefined distance from the filament or wire end by at least one projection and the projection is formed on an inner contour of the mounting recess. In the case of the method according to the invention, the basic stiffness of the filament or wire bundle or the seal is not adjusted until after mounting or until the time the brush seal is mounted in the housing. In the process, the filaments or wires are clamped between one or more projections of the inner contour of the mounting recess of the housing. The distance of the projection(s) from the filament or wire end may be varied so that the free filament length and thus the basic stiffness of the brush seal may be adapted individually to the requirements of the environment being sealed.

In advantageous embodiments of the method according to the invention, the housing in which the brush seal is mounted may be a structural element of an aircraft or stationary gas turbine, a compressor, a steam turbine or a machine tool. Basically, the brush seal can be used in all machines in which a gap between two structural elements of the machine must be sealed.

Other advantages, features and details of the invention are disclosed in the subsequent description of an exemplary embodiment that is depicted graphically.

### BRIEF DESCRIPTION OF THE DRAWING

The FIGURE shows a schematic sectional representation of a brush seal 10.

### DETAILED DESCRIPTION OF THE DRAWING

The brush seal 10 is made of a sealing element 12, wherein the sealing element 12 includes a plurality of filaments or wires, which are joined at a filament or wire end 16 to form a filament or wire bundle 14. One can see that the filament or wire end 16 is arranged in a mounting recess 22 of a two-part housing 20a, 20b. The filament or wire bundle 14 projects from the housing 20a, 20b on the free end 30, which is opposite from the filament or wire end 16. The individual filaments or wires in this case are made of metal, a metal alloy, plastic or ceramic.

Opposing projections 24, 26 are formed on an inner contour 18 of the mounting recess 22. The embodiment of the projections 24, 26 is such that the filament or wire bundle 14 is clamped by the projections 24, 26 at a predefined distance from the filament or wire end 16. However, it is also possible for a circumferential projection on the inner contour 18 of the mounting recess 22 to be formed. The clamping of the filament or wire bundle 14 produces a shortening in the so-called free filament length, thereby modifying the basic stiffness of the sealing element 12 or of the filament or wire bundle 14. In the present exemplary embodiment, the basic stiffness of the brush seal 10 increases overall due to the shortening of the free filament length. This makes it clear that the brush seal 10 has a free filament length Fv prior to mounting in the housing 20a, 20b, which is greater than the free filament length Fm after the brush seal has been mounted. To achieve the clamping effect, in this case the sealing element 12 is inserted into a corresponding partial area of the mounting recess 22 of one of the two housing parts 20a, 20b. Subsequently, the remaining housing part is connected to the first housing part, wherein the projections 24, 26 clamp the filament or wire bundle 14 at a predetermined distance from the filament or wire end 16.

It is also possible to use this procedure to compensate for eccentricities and/or tolerances already during mounting.

In addition, it is evident that the filament or wire end 16 is made of a core wire 38, around which a plurality of filaments or wires is wound, and a clamping element 36, wherein the clamping element 36 is used for fixing and bundling the filaments and wires. In the depicted exemplary embodiment, the clamping element 36 is configured as a clamping tube.

In addition, one can see that a first supporting surface 32, on which the free end 30 is at least partially supported, is formed on the inner contour 18 of the mounting recess 22 in the area of an outlet opening 28 for the free end 30 of the filament or wire bundle 14. A second supporting surface 34 for the free end 30 of the filament or wire bundle 14 is formed on the area of the inner contour 18 opposite from the supporting surface 32. The first and second supporting surfaces 32, 34 in this case provide a supporting or covering function. In addition, the first supporting surface 32 is configured to be spaced apart from the free end 30 of the filament or wire bundle 14, thereby avoiding undesired contact between the housing part 20b and opposing machine parts (not shown).

1.-12. (canceled)

13. A brush seal, comprising:
a housing including a mounting recess, wherein a projection is formed on an inner contour of the mounting recess; and
a sealing element including a plurality of filaments or wires that are joined at a filament or wire end to form a filament or wire bundle, wherein the filament or wire end is arranged in the mounting recess and wherein a free end of the filament or wire bundle that is opposite from the filament or wire end protrudes from the housing, and further wherein the filament or wire bundle is clamped by the projection at a predefined distance from the filament or wire end.

14. The brush seal according to claim 13, wherein the projection is formed as a projection that is at least partially circumferentially on the inner contour.

15. The brush seal according to claim 13, further comprising a second projection formed on the inner contour of the mounting recess and wherein the projection and the second projection are formed opposite from each other on the inner contour.

16. The brush seal according to claim 13, further comprising a supporting surface formed on the inner contour of the mounting recess in an area of an outlet opening for the free end of the filament or wire bundle, and wherein the free end is at least partially supported on the supporting surface.

17. The brush seal according to claim 16, further comprising a second supporting surface formed on an area of the inner contour opposite from the supporting surface.

18. The brush seal according to claim 13, wherein the filament or wire end includes a core wire around which the plurality of filaments or wires are wound and a clamping element, wherein the clamping element fixes and bundles the filaments or wires.

19. The brush seal according to claim 13, wherein the filament or wire end has a welding area or adhesion area for fixing and bundling the filaments or wires.

20. The brush seal according to claim 13, wherein the housing is configured to be multi-piece or one-piece.

21. The brush seal according to claim 16, wherein the supporting surface is spaced apart from the free end of the filament or wire bundle.

22. The brush seal according to claim 13, wherein the housing is a structural element of an aircraft or stationary gas turbine, a compressor, a steam turbine or a machine tool.

23. A method for mounting a sealing element in a housing, comprising the steps of:
inserting the sealing element in a mounting recess of the housing; and
clamping a filament or wire bundle of the sealing element at a predefined distance from a filament or wire end of the sealing element by a projection formed on an inner contour of the mounting recess.

24. The method according to claim 23, wherein the housing is a structural element of an aircraft or stationary gas turbine, a compressor, a steam turbine or a machine tool.
